(19) United States
(12) Patent Application Publication
(10) Pub. No.: US 2023/0082900 A1
(43) Pub. Date: Mar. 16, 2023

(54) SYSTEM AND METHOD FOR ACCELERATING THE MATURATION PROCESS OF AN ALCOHOLIC BEVERAGE

(71) Applicant: Weideman LLC, Almont, MI (US)

(72) Inventors: Aaron WEIDEMAN, Almont, MI (US); John LEWIS, Metamora, MI (US)

(73) Assignee: Weideman LLC, Almont, MI (US)

(21) Appl. No.: 17/447,319

(22) Filed: Sep. 10, 2021

(51) Int. Cl. C12G 3/07; C12H 1/22; C12H 6/02

(52) U.S. Cl. CPC C12G 3/07; C12H 1/22; C12H 6/02

(57) ABSTRACT

A system and method is disclosed for accelerating the maturation of an alcoholic beverage including distilled spirits (e.g., whiskey or bourbon). The system and method may comprise assembling a maturation stave from at least one species of wood. The maturation stave may be charred, and the char removed a predetermined number of times. The char may be removed by brushing along the grain of the wood. The maturation stave may then be placed within a container (e.g., a glass bottle) that includes the alcoholic beverage until the distilled spirit has reached a predetermined maturation level (e.g., alcoholic beverage has achieved a given color, smoothness, flavor, or taste). It is also contemplated the container may be heated and cooled a predetermined number of timed-temperature cycles until the alcoholic beverage has reached the predetermined maturation level.

### TECHNICAL FIELD

The present disclosure relates to a system and method for accelerating the maturation and aging of an alcoholic beverage (e.g., a distilled spirit).

### BACKGROUND

Alcoholic beverages including alcoholic spirits like whiskey typically employ a conventionally known process. For instance, a “malting” process is typically the first step employed where a grain (e.g., barley) may be moistened with water allowing it to germinate. This malting process allow enzymes to be released converting unfermentable starch into fermentable sugars. Next, a “mashing” process is employed to extract the fermentable sugars by agitating the ground grains in a mash tun with hot water. The mashing process is intended to produce a mixture (i.e., “mash” or “wort”) that is comprised of simple sugars. A “fermentation” process may then introduce the mash/wart with a yeast compound where the simple sugars can be converted to alcohol. A “distillation” process may then use a still (e.g., a pot or column still) to separate/evaporate the alcohol from water and other substances. The evaporated alcohol may then be cooled using a condenser unit thereby providing an “unaged” or “distillate” whiskey.

Generally, the distillation process may not require an extended period to complete (e.g., typically a few days). While the unaged whiskey is considered consumable or drinkable, it is generally clear in color and may not have the same taste or color many associate with a fully aged whiskey. Therefore, unaged whiskey typically undergoes a maturation process where a producer attempts to improve the unaged whiskey's taste, color, and smoothness. Traditionally, the maturation process involves placing the unaged whiskey into wooden barrels which may be stored in temperature and humidity-controlled facilities (i.e., warehouses) for several years. Producers may mature/age a given whiskey from anywhere between three to twenty years.

While maturation is typically employed by producers of alcoholic beverages like whiskey, there are known drawbacks to the maturation process. First, maturation involves considerable costs related to purchasing or manufacturing the wood barrels (typically made of oak) that the whiskey is stored in during the aging process. Also, the wood barrels the large, temperature-controlled warehouses used during the aging process add significant costs to whiskey production. The time necessary to age whiskey (e.g., 3 years, 5 years, 10 years) also require producers to wait before profits from the aged whiskey may be realized. If anything goes wrong during the aging process, a producer may incur loses of any potential profits. Even during a successful maturation process, losses are incurred because whiskey naturally evaporates through the wood barrels over the course of being aged. And the longer whiskey is aged, a greater amount of whiskey will evaporate again decreasing the amount of fully aged whiskey that is eventually available for sale.

### SUMMARY

A method and system are disclosed for accelerating a maturation level of an alcoholic beverage, including distilled spirits such as whiskey. A maturation stave is assembled from at least one species of wood. The maturation stave is charred and the char is then removed from the maturation stave a predetermined number of charring cycles (e.g., at least 2 charring cycles). The charring may be removed from the maturation stave by brushing along a grain of the at least one species of wood. The brushing may be done using a wire brush.

It is contemplated that in response to the predetermined number of charring cycles being completed, the maturation stave may be re-charred a final time to the same or different level than during the charring cycles. The maturation stave is then submerged within a container (e.g., a glass bottle, plastic bottle, or wood barrel) that includes the alcoholic beverage until the alcoholic beverage has reached a predetermined maturation level. The predetermined maturation level may be based on the alcoholic beverage achieving a predetermined color, flavor, or taste.

The alcoholic beverage may also, or alternatively, be heated and cooled a predetermined number of heating/cooling cycles after the maturation stave has been submerged until the alcoholic beverage has reached a predetermined maturation level. During the heating/cooling cycles, the alcoholic beverage within the container may be heated and cooled between a predefined heating temperature range and predefined cooling temperature range for a predefined heating time and a predefined cooling time. It is contemplated the predefined heating temperature range and the predefined heating time may vary between each of the predetermined number of heating/cooling cycles. It is also contemplated the predefined cooling temperature range and the predefined cooling time may vary between each of the predetermined number of heating/cooling cycles.

It is contemplated the maturation stave may be attached to a topper which may be used to seal the container that includes the alcoholic beverage from ambient air. It is also contemplated that a cork may be positioned between the topper and the maturation stave. The maturation stave may be alternatively be attached to a surface of the container. The maturation stave may also be placed within the container so as to float within the alcoholic beverage. If floating, the maturation stave may include a weighting element to help ensure the maturation stave remains submerged within the liquid.

### BRIEF DESCRIPTION OF THE DRAWINGS

FIG. 1 illustrates a container that includes a maturation stave for accelerating the maturation of a distilled spirit.

FIG. 2 illustrates an alternative container that includes a maturation stave for accelerating the maturation of a distilled spirit.

FIG. 3 illustrates a flow diagram for generating a maturation stave for use in accelerating the maturation of a distilled spirit.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As discussed above, an alcoholic beverage produced from the distillation process is not the final product many consumers may purchase. For instance, an unaged whiskey may be clear in color and may not have the desired texture or taste of aged or “matured” whiskey. Producers therefore employ a maturation process to improve the taste, color, and smoothness of a given spirit. In whiskey production, the distilled or unaged whiskey may be placed in large wood barrels located within large temperature-controlled storage locations to acquire a desired flavor and to generate the golden-brown color typically associated with whiskey. The maturation or aging process for alcoholic spirits, including whiskey, may require several years to complete.

Again, there may be drawbacks to the maturation process. For instance, producers may be required to manufacture or purchase wood barrels to age the distilled whiskey. Each wood barrel (which is typically assembled out of oak wood) can be costly. Laws and regulations may also require whiskey producers only use a wood barrel once, therefore requiring new barrels for each batch of distillate whiskey being aged.

Variations in the sourcing of wood (or the type of wood) or how the wood barrel is constructed can also affect the final whiskey product. For instance, a whiskey producer may “char” the wood barrels by burning the interior wood section of the barrel for a short period of time. It is thought the charred interior of the wood barrel may act as a filter, changing or possibly eliminating various congeners in the distillate whiskey. It is also contemplated that charring may allow the aging whiskey to extract natural flavors of the wood.

While the above discuss the maturation process as it applies to distilled whiskey, many of the same issues are common to other alcoholic beverages such as wine, beer, and brandy. A system and method is therefore desirable that may accelerate the maturation of alcoholic beverages while still maintaining the taste, coloring, and smoothness of the final aged and matured alcoholic beverage. By accelerating the maturation process, costs incurred during the aging and maturation process may be reduced.

It would also be desirable for alcoholic beverages to be matured in smaller containers (e.g., glass or plastic bottle). For instance, a glass or plastic bottle would not require as much room as the temperature-controlled storage locations currently necessary for wood barrels. Second, glass or plastic bottles would also reduce the amount of evaporation that may occur when the alcoholic beverage is aged in wood barrels.

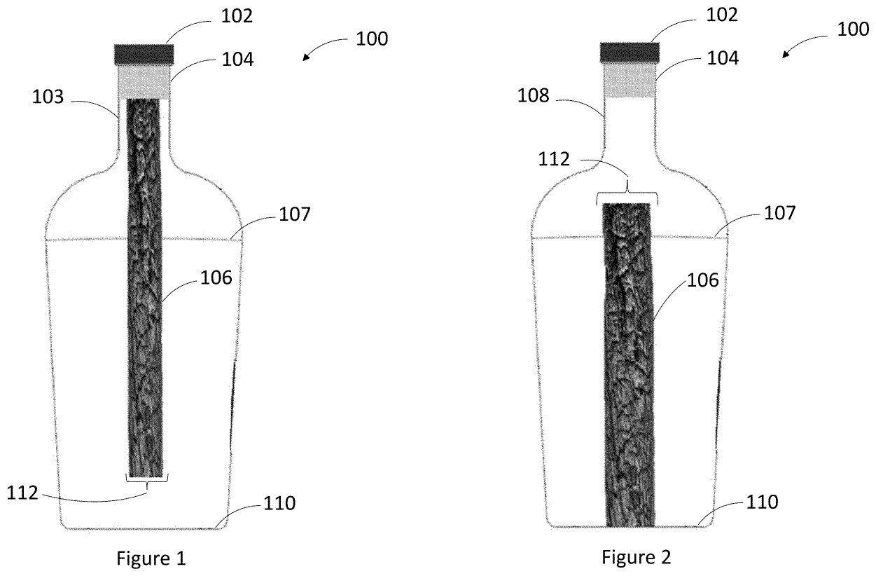

FIG. 1 illustrates an embodiment of a container 100 that may be used to mature an alcoholic beverage. The alcoholic beverage may be a distilled spirit (e.g., whiskey) or As illustrated the container 100 may be a bottle that can be used for sale to consumers once the distilled spirit has been fully matured. However, it is also contemplated the container 100 may be a wood barrel or other large vessel which could be used to mature large quantities of alcoholic beverages. The container 100 may be manufactured using a material suitable for storing an alcoholic beverage which helps prevent oxygen ingress and evaporation of the distilled spirit. For instance, the container 100 may be manufactured using a glass, porcelain, or plastic material. It is contemplated the material used may also allow a producer the capability of creating unique designs or shapes.

A topper 102 or cap may be used to seal the opening 103 of the container 100. The topper 102 may include a sealing gasket 104 constructed using a cork material or other synthetic material (e.g., rubber) suitable for sealing the opening 103 of the container 100 from ambient air. It is also contemplated topper 102 may be constructed as a screw or threaded closure that may not require sealing gasket 104.

The topper 102 (i.e., lid) may also include a maturation stave 106 that is used to mature the alcoholic beverage within container 100. For instance, the maturation stave 106 may be used to mature the taste, color and/or smoothness of the alcoholic beverage. It is contemplated the maturation stave 106 may be constructed to encompass a given length of the interior of container 100. For instance, the maturation stave 106 may extend from the opening 103 of the container 100 downward into an alcoholic beverage 107 (e.g., a distilled spirit such as whiskey). The maturation stave 106 may also extend near or at a given distance above a bottom surface 110 of the container 100 (e.g., ½ inch above the bottom surface 110). However, the maturation stave 106 may also be constructed to span various lengths of the container 100.

The maturation stave 106 may be constructed of a single species of wood (e.g., oak, cherry) or multiple combined species of wood. It is also contemplated the maturation stave 106 may designed to have a given circumference. For instance, the maturation stave 106 may be designed to be have a circumference 112 that is smaller than the circumference of the opening 103 of the container 100 (e.g., ⅝ inches smaller than opening 103). The circumference of the maturation stave 106 may also vary depending upon application. But when attached to topper 102 and/or gasket 104 the maturation stave 106 would need to be less than the circumference of the bottle so that it may exit and be removed from the bottle.

FIG. 2 illustrates an alternative embodiment where maturation stave 106 is connected to the bottom 110 of the bottle. The maturation stave 106 may be connected to bottom 110 during manufacturing of the container 100. Or the maturation stave 106 may be connected to the bottom 110 using an adhesive. When connected to the bottom 110, the circumference 112 of maturation stave 106 may extend (i.e., be larger) than the circumference of the opening 108 of the bottle. Multiple maturation staves 106 may be connected to the bottom 110 of the bottle. It is also contemplated the maturation staves 106 may be connected to other portions (e.g., a side) of the container 100 instead of being connected to the bottom 110. For instance, multiple smaller maturation staves 106 may be connected along the interior wall of the container 100.

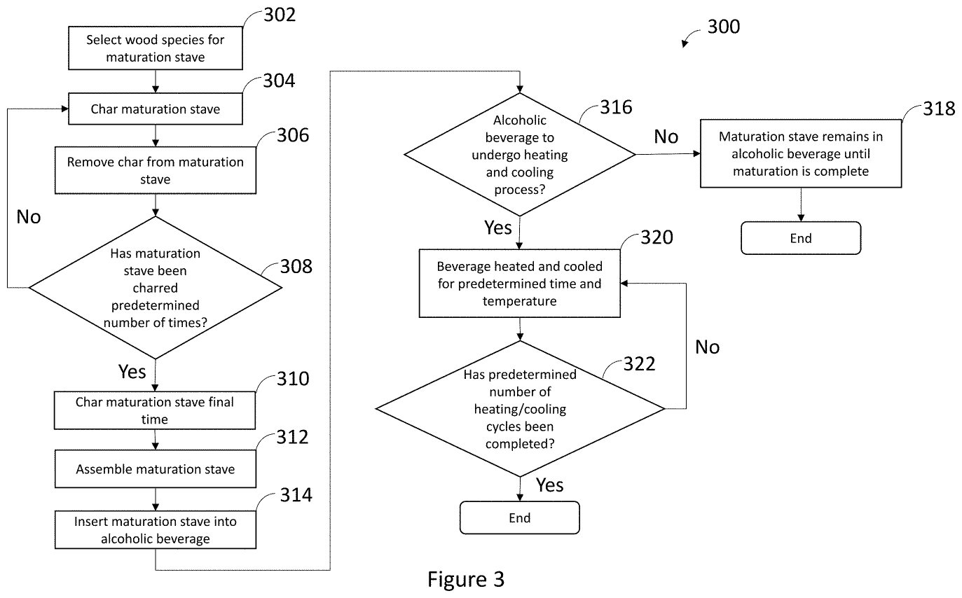

FIG. 3 illustrates a flow diagram 300 for construction of the maturation stave 106. At step 302 a species of wood is selected to make the maturation stave 106. Again, the maturation stave 106 may be constructed using one species of wood. Or the maturation stave 106 may be constructed using several species of wood that are connected together.

At step 304, the maturation stave 106 may be burnt and a full char may be formed along an exterior surface of the maturation stave 106. For instance, the wood may be burnt to a high using a high level of heat until a full charcoal is formed along the exterior of the maturation stave 106. It is also contemplated the maturation stave may be burnt according to one or more industry char levels conventionally employed by spirit manufacturers.

At step 306, the char may be removed from the maturation stave 106. It is contemplated the char may be removed by brushing along or near a surface of the maturation stave 106 that is parallel with the grain of the wood. However, it is also contemplated that the maturation stave 106 may be brushed along various directions of the grain of the wood. A wire brush or similar device may be used for removing the char at step 306.

At step 308, it is determined if the maturation stave 106 has been burnt and the char has been removed a predetermined number of times. If the answer is no, flow diagram 300 returns to step 304 so that the process may be repeated. It is contemplated that the maturation stave 106 should be burnt and the char removed at least two times. But depending upon the alcoholic spirit being manufactured, steps 304 and 306 may need to be repeated 3 or more times.

When it is determined the answer at step 308 is yes, the flow diagram may proceed to step 310 where a final full char burn of the maturation stave 106 may be performed. After the final full char burn, a final brushing of the maturation stave 106 may also occur. Again, the final brushing may be performed using a wire brush along the grain of the wood. At step 310, the maturation stave 106 is burnt again one more time to a full exterior charcoal look and then cleaned with high pressure air to remove particulates.

At step 312 it is determined how the maturation stave 106 will be assembled. For instance, the maturation stave 106 may be connected to the topper 102 and/or gasket 104 for insertion within the container 100 as discussed above with regards to FIG. 1. Or the maturation stave 106 may be inserted within the container 100 in an alternative manner such as being inserted within a bottle as discussed above with regards to FIG. 2. At step 314 an alcoholic beverage is inserted into the bottle and the maturation stave 106 is fully submersed into the alcoholic beverage.

At step 316 it is determined whether the container 100 will undergo a predetermined number of heating and cooling cycles to help accelerate the maturation process. If no, the heating and cooling cycles are not performed and the flow diagram 300 proceeds to step 318 where the maturation stave 106 may remain within the container 100 until the alcoholic beverage 107 has been matured to a achieve a desired color, flavor (taste), and/or smoothness. However, it is also contemplated the maturation stave 106 may remain within the alcoholic beverage 107 after the predetermined time allowing further maturation of the alcoholic beverage 107.

If yes, flow diagram 300 proceeds to step 320 where the container 100 may be heated and cooled for a predetermined amount of time at a predetermined temperature. The container 100 may be heated for a predetermined amount of time at a predetermined temperature so that the maturation stave 106 absorbs the alcoholic beverage 107. The container 100 may then be cooled so the maturation stave 106 shrinks and the alcoholic beverage 107 is exerted (i.e., squeezed) back into the container 100. But the heating/cooling time and temperature range may depend upon the alcoholic beverage 107 being matured and the size and material of the container 100. For instance, the amount of time the container 100 is heated or cooled may range from 15 minutes to 48 hours. The alcoholic beverage may also be heated within a temperature range of 60 degrees Fahrenheit to 90 degrees Fahrenheit and cooled within a temperature range of 60 degrees Fahrenheit to 30 degrees Fahrenheit. It is also contemplated the optimal temperature for aging may occur around 60 degrees Fahrenheit with a variation between heating and cooling the alcoholic beverage being plus/minus 10 degrees Fahrenheit. For distilled spirits (e.g., whiskey) the alcoholic beverage may preferably be heated to a temperature near or above 70 degrees Fahrenheit and then cooled to a temperature near or below 50 degrees Fahrenheit.

At step 322, it is determined whether a predetermined number of heating and cooling cycles has been completed such that the alcoholic beverage 107 is matured to a achieve a desired color, flavor (taste), and/or smoothness. If no, the flow diagram 300 may return to step 320 to again heat and cool the maturation stave. If yes, the maturation stave 106 may be removed after the predetermined number of heating/cooling cycles has been completed. However, it is again contemplated the maturation stave 106 may remain permanently within the bottle after step 322 is complete. Lastly, it is contemplated the amount of time and temperature range may be modified between each predetermined heating/cooling cycle. The time and temperature range may be modified to further accelerate the maturation process or to achieve a desired maturation of the alcoholic beverage 107.

While the above discloses a maturation stave which may submerged within a container that includes alcoholic beverage, it is contemplated other alternatives may also be used to accomplish the accelerated maturation disclosed. For instance, the container may be a wood barrel where many of the steps disclosed in FIG. 3 (e.g., steps 302-312, 316-322) may be done on an interior surface of the wood barrel.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for accelerating a maturation level of an alcoholic beverage, comprising:
assembling a maturation stave from at least one species of wood;
charring the maturation stave and removing at least a portion of the char from the maturation stave a predetermined number of charring cycles; and
submerging the maturation stave within a container that includes the alcoholic beverage until the alcoholic beverage has reached a predetermined maturation level.

2. The method of claim 1, wherein the predetermined maturation level is based on the alcoholic beverage achieving a predetermined color.

3. The method of claim 1, wherein the predetermined maturation level is based on the alcoholic beverage achieving a predetermined flavor.

4. The method of claim 1, wherein the predetermined maturation level is based on the alcoholic beverage achieving a predetermined taste.

5. The method of claim 1, further comprising: in response to the predetermined number of charring cycles being completed, re-charring the maturation stave a final time.

6. The method of claim 1, wherein the charring is removed by brushing along a grain of the at least one species of wood.

7. The method of claim 6, wherein the charring is removed using a wire brush.

8. The method of claim 1, further comprising: attaching the maturation stave to a topper, wherein the topper seals the container that includes the alcoholic beverage from ambient air.

9. The method of claim 1, further comprising: attaching the maturation stave to a surface of the container.

10. The method of claim 1, wherein the alcoholic beverage is a distilled spirit.

11. A method for accelerating a maturation level of an alcoholic beverage, comprising:
assembling a maturation stave from at least one species of wood;
charring the maturation stave and removing the char from the maturation stave a predetermined number of charring cycles; and
submerging the maturation stave within a container that includes the alcoholic beverage; and
heating and cooling the alcoholic beverage a predetermined number of heating/cooling cycles until the alcoholic beverage has reached a predetermined maturation level.

12. The method of claim 11, wherein the alcoholic beverage is heated between a predefined heating temperature range.

13. The method of claim 12, wherein the alcoholic beverage is heated for a predefined heating time.

14. The method of claim 13, wherein the predefined heating temperature range and the predefined heating time varies between each of the predetermined number of heating/cooling cycles.

15. The method of claim 11, wherein the alcoholic beverage is cooled between a predefined cooling temperature range.

16. The method of claim 15, wherein the alcoholic beverage is cooled for a predefined cooling time.

17. The method of claim 16, wherein the predefined cooling temperature range and the predefined cooling time varies between each of the predetermined number of heating/cooling cycles.

18. The method of claim 11, further comprising: in response to the predetermined number of charring cycles being completed, re-charring the maturation stave a final time.

19. The method of claim 11, wherein the charring is removed by brushing along a grain of the at least one species of wood.

20. A system for accelerating a maturation level of an alcoholic beverage, comprising:
a maturation device assembled from at least one species of wood, at least a portion of the maturation device being charred, and the portion of the maturation device that is charred is then brushed, wherein the maturation device is charred and brushed a predetermined number of charring cycles; and
an alcoholic beverage that is exposed to the maturation device until the alcoholic beverage has reached a predetermined maturation level.
